(19) United States
(12) Patent Application Publication
(10) Pub. No.: US 2013/0242607 A1
(43) Pub. Date: Sep. 19, 2013

(54) BACKLIGHT MODULE

(71) Applicants: Kang-Yu Lai, Taichung City (TW); Ching-Lung Chang, Taoyuan County (TW)

(72) Inventors: Kang-Yu Lai, Taichung City (TW); Ching-Lung Chang, Taoyuan County (TW)

(73) Assignee: CHUNGHWA PICTURE TUBES, LTD., Taoyuan (TW)

(21) Appl. No.: 13/495,999

(22) Filed: Jun. 13, 2012

(30) Foreign Application Priority Data
Mar. 19, 2012 (TW) 101109342

(51) Int. Cl. F21V 9/16; F21V 8/00

(52) U.S. Cl. 362/611; 362/84

(57) ABSTRACT

A backlight module is provided. The backlight module includes a light source and a group of replaceable optical elements. The light source emits a first light. The replaceable optical elements receive the first light and backlight light is then excited, wherein the replaceable optical elements include a first replaceable optical element and a second replaceable optical element. The first replaceable optical element has a first phosphor. The first phosphor can be excited by light and emits second light. The second replaceable optical element has a second phosphor. The second phosphor can be excited by light and emits third light.

### CROSS-REFERENCE TO RELATED APPLICATION

This application claims the priority benefit of Taiwan application serial no. 101109342, filed on Mar. 19, 2012. The entirety of the above-mentioned patent application is hereby incorporated by reference herein and made a part of this specification.

### BACKGROUND OF THE INVENTION

1. Field of the Invention

The present invention relates to a backlight module, and more particularly to a backlight module in which a white light is formed by mixing polychromatic light.

2. Description of Related Art

Since light emitting diodes (LED) have advantages of low pollution, low power consumption, short response time, long service life, etc., they have been widely used in light sources of the backlight module of the display. Currently, due to the high fabricating cost of LED in color mixing with red, green and blue light, using the blue light emitting diode with the yellow fluorescent powder to form a white light has been the mainstream of the white light emitting diodes in the market.

FIG. 1 shows a backlight spectrum distribution diagram of a conventional light source, wherein a yellow fluorescent powder is excited by a blue light emitting diode and then a white light is formed with color mixing thereof. Referring to FIG. 1, the red light wavelength of 600 nm to 700 nm and the green light wavelength of 500 nm to 600 nm of the backlight spectrum is formed when the yellow fluorescent powder is excited by the blue light. Therefore, compared to the blue light wavelength of 400 nm to 500 nm, the conventional backlight spectrum has a lower energy in the red light wavelength and the green light wavelength, and the conventional backlight spectrum has no separate peak for each of the red light wavelength and the green light wavelength.

FIG. 2 shows a color gamut of a panel with a conventional light source. Referring to FIG. 2, the area of the triangle surrounded by the dashed-line 202 is 100% NTSC which is defined by CIE 1931. The area of the triangle surrounded by the solid line 204 is the color gamut of a panel with the conventional light source. Since the spectrum of the conventional light source has no separate peak corresponding to the red color filter and the green color filter, the area of the pure color is reduced and the color saturation is further affected.

In actual operation, backlight modules with different specifications need corresponding mixing ratios of fluorescent powder so as to achieve the desired color saturation. However, such method may increase the development duration for the product, and the resulting backlight may also become a customized product.

### SUMMARY OF THE INVENTION

Aspects of the invention provide a backlight module having a high color saturation.

One embodiment of the present invention provides a backlight module including a light source and a group of replaceable optical elements. The light source emits a first light. The group of replaceable optical elements receives the first light and excites a backlight light, wherein the group of replaceable optical elements includes a first replaceable optical element and a second replaceable optical element. The first replaceable optical element has a first phosphor, and the first phosphor is excited by a light and emits a second light. The second replaceable optical element has a second phosphor, and the second phosphor is excited by a light and emits a third light.

In an exemplary embodiment of the present invention, the first replaceable optical element is a light guide plate, a diffusion film or a prism film, and the second replaceable optical element is a light guide plate, a diffusion film or a prism film.

In an exemplary embodiment of the present invention, the first phosphor is disposed in the first replaceable optical element by doping, and the doping concentration of the first phosphor is related to the luminous intensity (brightness) of the second light.

In an exemplary embodiment of the present invention, the first phosphor is disposed on the first replaceable optical element by coating, and the thickness of the first phosphor is related to the luminous intensity of the second light.

In an exemplary embodiment of the present invention, the second phosphor is disposed in the second replaceable optical element by doping, and the doping concentration of the second phosphor is related to the luminous intensity of the third light.

In an exemplary embodiment of the present invention, the second phosphor is disposed on the second replaceable optical element by coating, and the thickness of the second phosphor is related to the luminous intensity of the third light.

In an exemplary embodiment of the present invention, the light source is at least a blue light emitting diode, and the first light is a blue light.

In an exemplary embodiment of the present invention, the second light is a red light, and the third light is a green light.

In an exemplary embodiment of the present invention, the backlight module further includes a third replaceable optical element, wherein the third replaceable optical element has a third phosphor, and the third phosphor is excited by a light and emits a fourth light.

In an exemplary embodiment of the present invention, the third phosphor is disposed in the third replaceable optical element by doping, and the doping concentration of the third phosphor is related to the luminous intensity of the fourth light.

In an exemplary embodiment of the present invention, the third phosphor is disposed on the third replaceable optical element by coating, and the thickness of the third phosphor is related to the luminous intensity of the fourth light.

In an exemplary embodiment of the present invention, the light source is at least an invisible light emitting diode, and the first light is an invisible light.

In an exemplary embodiment of the present invention, the second light is a red light, the third light is a green light, and the fourth light is a blue light.

In an exemplary embodiment of the present invention, the backlight module further includes at least a replaceable optical element with no phosphor, wherein the replaceable optical element with no phosphor is disposed between the first replaceable optical element and the second replaceable optical element.

In light of the above, in the backlight modules of the exemplary embodiments of the present invention, the phosphors of the replaceable optical elements can be stacked to each other, and the phosphors of different layers are excited by the first light so as to achieve a backlight spectrum with three separate color peaks, such as a backlight spectrum with a red color peak, a green color peak and a blue color peak. Therefore, the backlight spectrum of such backlight module has separate color peaks corresponding to the red color filter, green color filter and blue color filter of panel, and the color saturation of a panel with the backlight module is higher than conventional produces. In addition, since each of the phosphor of the replaceable optical elements is a phosphor with a single color, i.e., the phosphor is not obtained from mixing of multi-color, it is no need to consider the non-uniformity of the color distribution. In addition, simply and rapidly adjusting the existing replaceable optical elements according to the desired color saturation may greatly reduce the development duration and fabrication cost.

Other features and advantages of the invention will be further understood from the further technological features disclosed by the following embodiments of the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 shows a backlight spectrum distribution diagram of a conventional light source.

FIG. 2 shows color gamuts of a panel with a conventional light source and the panel with a backlight module of an embodiment of the present invention.

FIG. 3 is a schematic cross-sectional view illustrating a backlight module according to an exemplary embodiment of the present invention.

FIG. 4 is a schematic cross-sectional view illustrating a backlight module according to another exemplary embodiment of the present invention.

FIG. 5 is a schematic cross-sectional view illustrating a backlight module according to another exemplary embodiment of the present invention.

FIG. 6 is a schematic cross-sectional view illustrating a backlight module according to another exemplary embodiment of the present invention.

FIG. 7 shows backlight spectrum distribution diagrams of a backlight module of exemplary embodiments of the present invention and a conventional light source.

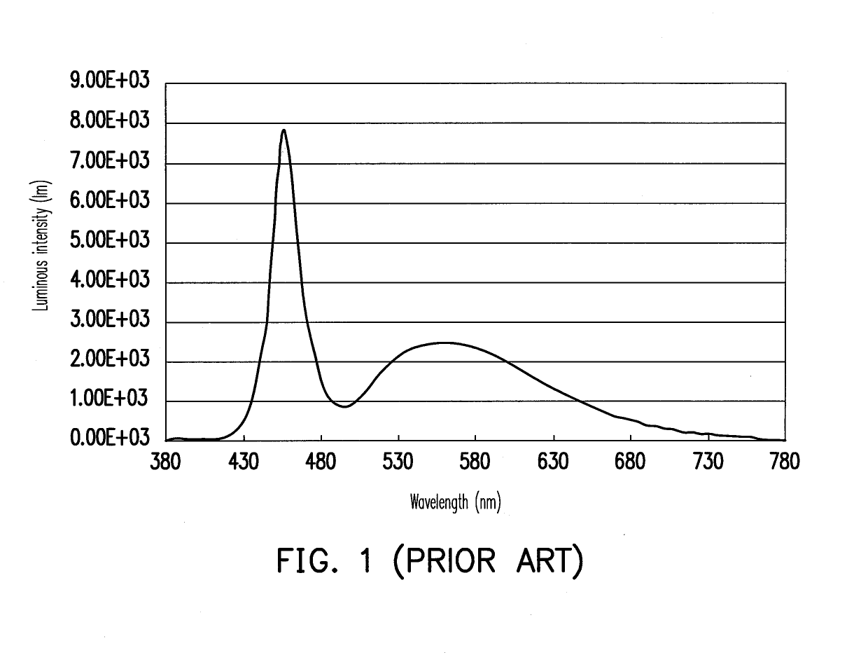

### DESCRIPTION OF EMBODIMENTS

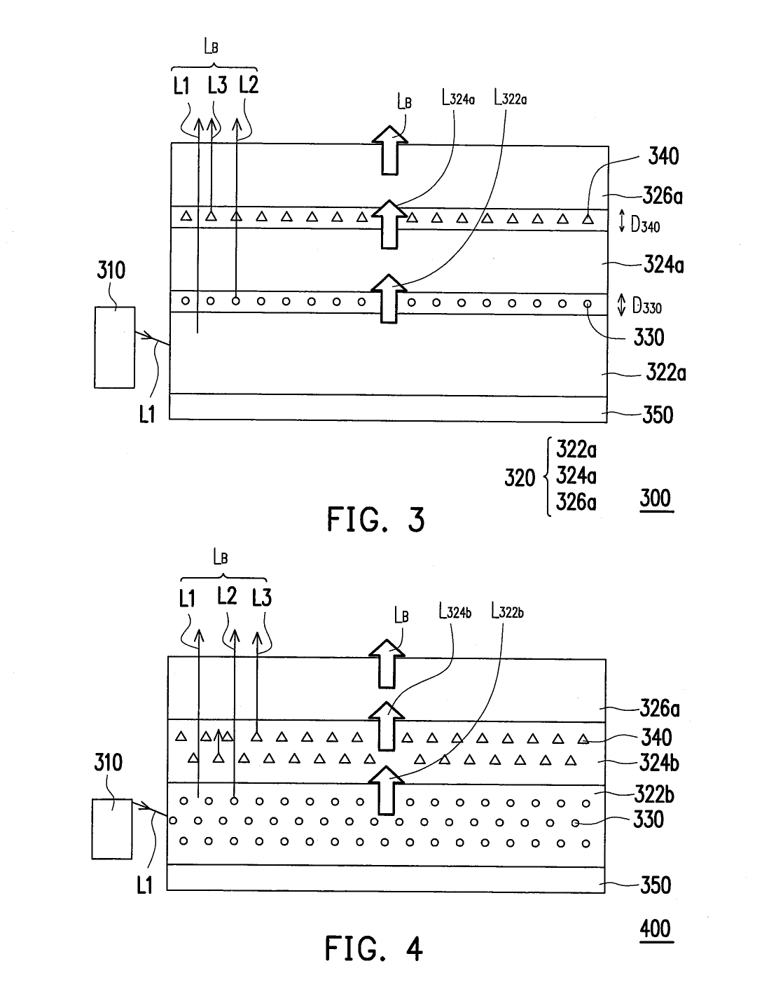

FIG. 3 is a schematic cross-sectional view illustrating a backlight module according to an exemplary embodiment of the present invention.

Referring to FIG. 3, the backlight module 300 of the embodiment includes a light source 310 and a group of replaceable optical elements 320, wherein the light source 310 emits a first light L1, and the group of replaceable optical elements 320 receive the first light L1 and excite a backlight light L_{B}. More specifically, the group of replaceable optical elements 320 includes a first replaceable optical element 322a and a second replaceable optical element 324a. Herein the first replaceable optical element 324a has a first phosphor 330 and the first phosphor 330 can be excited by a light to emit a second light L2. The second replaceable optical element 324a has a second phosphor 340, and the second phosphor 340 can be excited by a light to emit a third light L3. In addition, the backlight module 300 of the embodiment can have a plurality of optical elements selectively disposed therein according to various requirements. In the embodiment, an optical element 326a (e.g., a prism film without a phosphor) can be selectively disposed on the second replaceable optical element 324a.

The first phosphor 330 and the second phosphor 340 may be fluorescent powder, optical adhesive or any other material which can be excited by a light to emit a light with desired wavelength range. In the embodiment, the first phosphor 330 is a red fluorescent powder or any other chemical material which can be excited for emitting a red light, for example. And the second phosphor 340 is a green fluorescent powder or any other chemical material which can be excited for emitting a green light, but the present invention is not limited thereto. In other embodiments, the first phosphor can also be a green fluorescent powder or any other chemical material which can be excited to emit a green light, and the second phosphor is a red fluorescent powder or any other chemical material which can be excited for emitting a red light.

It has to be noted that different phosphors can be exited to emit different ranges of wavelength. In other words, the phosphors of the replaceable optical elements of the backlight module 300 of the embodiment can be adjusted according to color filters with different specifications or different light sources, so as to obtain the desired range of wavelength to achieve the required color saturation.

In the present embodiment, the light source 310 is a blue light emitting diode, for example, and the first light L1 is a blue light, but not limited thereto. In addition, the first replaceable optical element 322a and the light source 310 are disposed in parallel to form an edge-type light source, but the present invention is not limited thereto. In other embodiments, the light source and the first replaceable optical element can be perpendicularly disposed to form a direct-type light source.

The first replaceable optical element 322a and the second replaceable optical element 324a can be a light guide plate, a diffusion film, a prism film or an other optical film, respectively. In the embodiment, the first replaceable optical element 322a is a light guide plate, for example, so as to guide the first light L1 generated by the light source 310, and the first phosphor 330 of the first replaceable optical element 322a is excited and generates a second light L2.

In addition, in order to increase the ratio of light which is reflected from the bottom of the first replaceable optical element 322a, a reflecting sheet 350 is disposed beneath the light guide plate (the light guide plate is the first replaceable optical element 322a in this embodiment) of the backlight module 300 of the embodiment, so that more of the light can be reflected from the first replaceable optical element 322a. Herein the light L₃₂₂ₐ from the first replaceable optical element 322a is a mixed color light including the blue color of the first light L1 emitted by the light source 310 and the red color of the second light L2 generated by the excited first phosphor 330. Therefore, the color of the light L₃₂₂ₐ is close to the violet.

In the embodiment, the second replaceable optical element 324a is a diffusion film disposed on the first replaceable optical element 322a for example, so as to diffuse the light L₃₂₂ₐ from an the first replaceable optical element 322a and to diffuse the light L₃₂₂ₐ from a point light source (in which the light is concentrated as a point) into a surface light source (in which the light is uniformly distributed), and the second phosphor 340 of the second replaceable optical element 324a is excited and generates a third light L3, wherein the third light L3 is a green light. Therefore, the light L₃₂₄ₐ from the second replaceable optical element 324a becomes a white color light because of the mixture of red, blue and green light. Specifically, the color of the light L₃₂₄ₐ includes the blue color of the first light L1 emitted from the light source 310, the red color of the second light L2 generated by the first phosphor 330 and the green color of the third light L3 generated by the second phosphor 340.

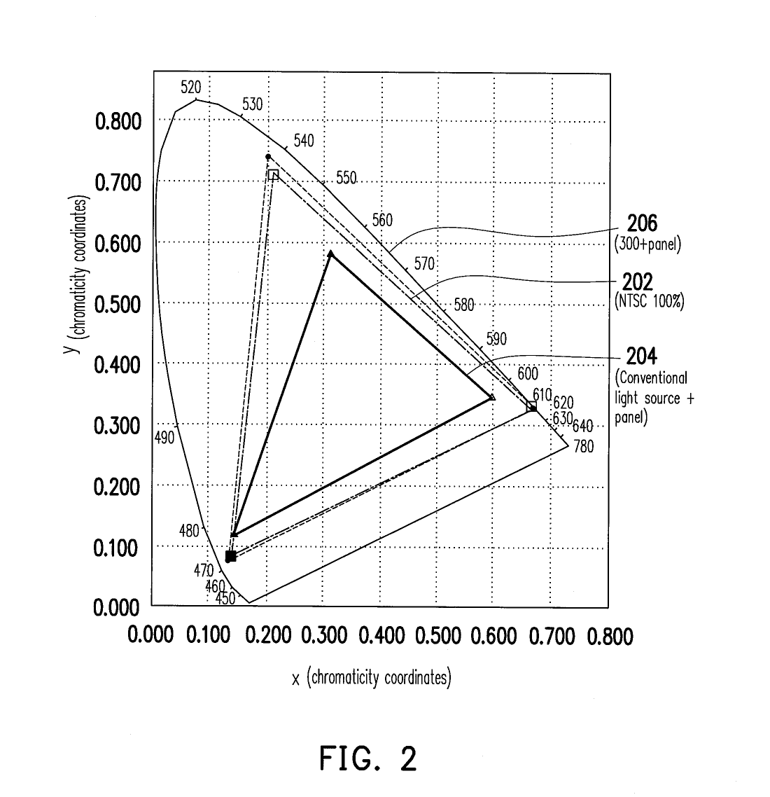

It should be noted that, the present invention is not limited to the types of the plurality of the replaceable optical elements 320 in the embodiment. The replaceable optical elements 320 are used to illustrate that in the backlight module 300 of the embodiment, the first replaceable optical element 322a having the first phosphor 330 and the second replaceable optical element 324a having the second phosphor 340 are stacked together, and the first phosphor 330 and the second phosphor 340 which are located in different layers are excited to achieve a backlight light having separate peaks in spectrum distribution for red, green and blue color. Therefore, the backlight spectrum of the backlight module 300 has separate color spectrum peaks corresponding to a red color filter, a green color filter and a blue color filter of a panel, and the color saturation of the panel can even surpass the area of 100% NTSC (shown as the triangular area surrounded by the dash-line 206 in FIG. 2) defined by CIE 1931.

In other embodiments, the first replaceable optical element and the second replaceable optical element are not limited to be the light guide plate or the diffusion film, and they can be any other optical element (optical film) usually disposed in the backlight module which is known by people having ordinary skill in the art of the invention field.

Additionally, the optical element 326a of the embodiment can be a prism film without phosphor for example, so as to refract the light L₃₂₄ₐ from from the second replaceable optical element 324a to the front view angle of the display device, so that the backlight light L_{B} of the optical element 326a can be concentrated to enhance the luminance. In the embodiment, since the optical element 326a has no phosphor, the color of the backlight light L_{B} and the color of the light L₃₂₄ₐ are similar.

In addition, in the embodiment, the first phosphor 330 and the second phosphor 340 are disposed on the surfaces of the first replaceable optical element 322a and the second replaceable optical element 324a respectively by coating process. Moreover, the thickness D₃₃₀ of the first phosphor 330 is related to the luminous intensity of the second light L2, i.e., changes the luminous intensity of L₃₂₂ₐ. The thickness D₃₄₀ of the second phosphor 340 is related to the luminous intensity of the third light L3, i.e., changes the luminous intensity of L₃₂₄ₐ, and further changes the luminous intensity of the backlight light L_{B} from the optical element 326a. In other words, the luminous intensity of the peaks in the backlight spectrum of the embodiment can be changed by adjusting the thickness D₃₃₀ of the first phosphor 330 and the thickness D₃₄₀ of the second phosphor 340.

In actual operating process, since the first phosphor 330 and the second phosphor 340 are located in different replaceable optical elements, it is no need to consider the non-uniformity of the phosphor distribution of the backlight module 300. In addition, simply and rapidly adjusting the existing replaceable optical elements according to the desired color saturation may greatly reduce the development duration and fabrication cost. For instance, excited lights with various spectrum peaks or luminous intensity can be achieved by establishing a source material data base of the replaceable optical elements having different phosphors with various coating materials or doping concentration, so as to meet the demands of different light sources or color filters with different specifications.

In addition, the phosphors can be either disposed on the replaceable optical elements by coating, or disposed in the replaceable optical elements by doping. FIG. 4 is a schematic cross-sectional view illustrating a backlight module according to another exemplary embodiment of the present invention.

Referring to FIG. 4, the backlight module 400 and the backlight module 300 of FIG. 3 are similar in structure, and similar components with similar functions are represented by the same reference numbers and are not repeated therein. One difference between the backlight module 400 and the backlight module 300 is that the first phosphor 330 and the second phosphor 340 are disposed in the first replaceable optical element 322b and the second replaceable optical element 324b respectively by doping process, and the present invention is not limited thereto. In the embodiment, the doping concentration of the first phosphor 330 is related to the luminous intensity of the second light L2, and the doping concentration of the second phosphor 340 is related to the third light L3.

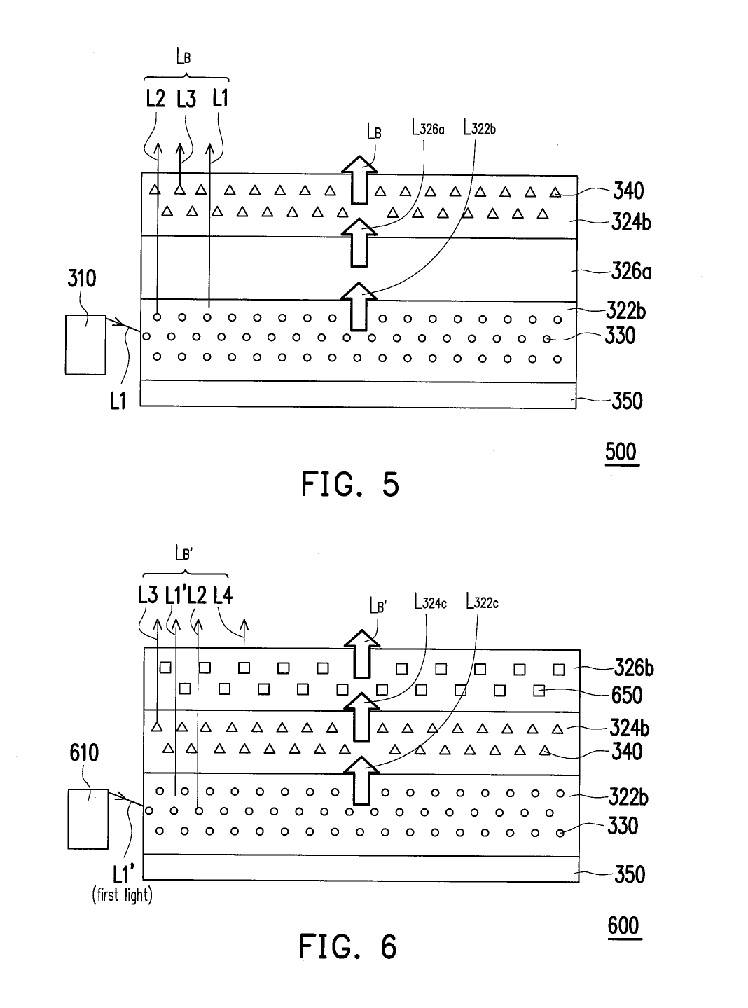

It has to be noted that, the locations of the first replaceable optical element and the second replaceable optical element are not limited in the present invention. In more detail, the first replaceable optical element and the second replaceable optical element can be adjacently stacked up and down to each other, or stacked up and down with an optical element without phosphor sandwiched therebetween. FIG. 5 is a schematic cross-sectional view illustrating a backlight module according to another exemplary embodiment of the present invention.

Referring to FIG. 5, the backlight module 500 and the backlight module 400 of FIG. 4 are similar in structure, and similar components with similar functions are represented by the same reference numbers and are not repeated therein. One difference between the backlight module 500 and the backlight module 400 is that the optical element 326a without phosphor disposed therein is disposed between the first replaceable optical element 322b and the second optical element 324b. Herein since the optical element 326a has no phosphor, the colors of the light L₃₂₆ₐ from the optical element 326a and the light L_{322b} from the first replaceable optical element 322b are similar.

Naturally, the light source of the backlight module can be the above-mentioned blue light emitting diode or any other type of light source. FIG. 6 is a schematic cross-sectional view illustrating a backlight module according to another exemplary embodiment of the present invention.

Referring to FIG. 6, the backlight module 600 and the backlight module 400 of FIG. 4 are similar in structure, and similar components with similar functions are represented by the same reference numbers and are not repeated therein. One difference is that the light source 610 of the backlight module 600 of the embodiment is at least an invisible light emitting diode. Herein the first light L1′ is an invisible light.

In addition, the backlight module 600 of the embodiment further includes a third replaceable optical element 326b, wherein the third replaceable optical element 326b has a third phosphor 650, and the third phosphor 650 can be excited by a light and emits a fourth light L4. In the embodiment, the third phosphor 650 may be a blue fluorescent powder, an optical adhesive or any other chemical material which can be excited to emit a blue light, and the fourth light L4 is a blue light. Furthermore, the third phosphor 650 can be disposed in the third replaceable optical element 326b by doping, wherein the doping concentration of the third phosphor 650 is related to the luminous intensity of the fourth light L4. However, the present invention is not limited thereto. In other embodiments, the third phosphor can be disposed on the third replaceable optical element by coating, and the thickness of the third phosphor is related to the luminous intensity of the fourth light.

In the embodiment, the light source 610 emits a first light L1′. The first light L1′ excites the first phosphor 330 of the first replaceable optical element 322b, and the light L_{322c} from the first replaceable optical element 322b includes an invisible light and a red light. And then, the light L_{322c} excites the second phosphor 340 of the second replaceable optical element 324b, and the light L_{324c} from the second replaceable optical element 324b includes an invisible light, a red light and a green light. After that, the light L_{324c} excites the third phosphor 650 of the third replaceable optical element 326b, and the light L_{B} from the third replaceable optical element 326b includes an invisible light, a red light, a green light and a blue light, and then they are mixed to form a white light.

It has to be illustrated that in the backlight module 600 of the embodiment, the first replaceable optical element 322b having the first phosphor 330, the second replaceable optical element 324b having the second phosphor 340 and the third replaceable optical element 326a having the third phosphor 650 are stacked together, and the first phosphor 330, the second phosphor 340 and the third phosphor 650 which are located in different layers are excited to achieve a backlight light having separate peaks in spectrum distribution for red, green and blue colors. Therefore, the backlight spectrum of the backlight module 600 has separate color peaks corresponding to a red color filter, a green color filter and a blue color filter of a panel, and the color saturation of the panel with backlight module 600 can be further improved.

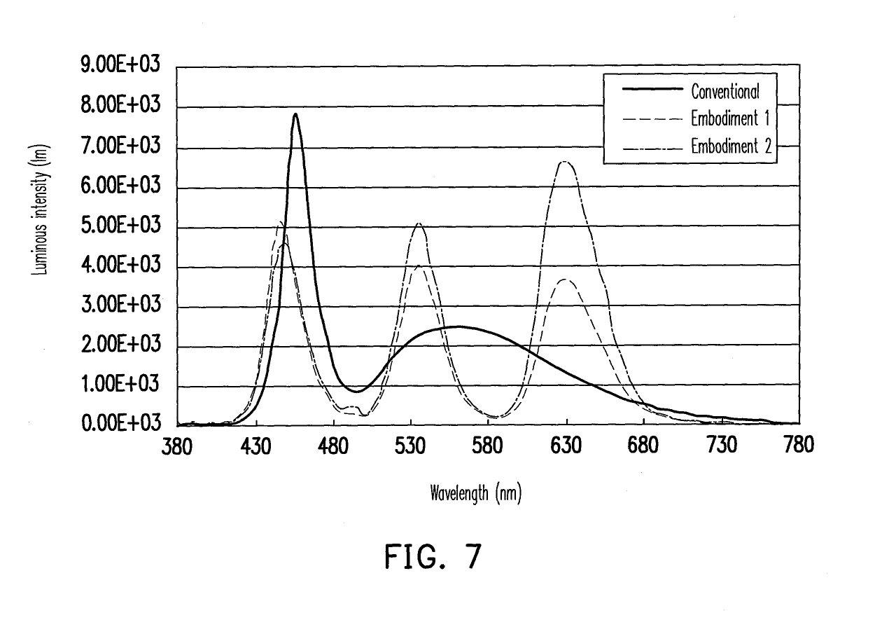

In order to illustrate the embodiment of the present invention more clearly, a backlight module in which separate peaks of spectrum and superior color saturation can be achieved by stacking the replaceable optical elements having single color phosphors is further described with the following FIG. 7 and Table 1. The specification of the color saturation for a panel with a backlight module is assumed to be W(x,y)=(0.313,0.329).

FIG. 7 shows backlight spectrum distribution diagrams of backlight modules of exemplary embodiments of the present invention and a conventional light source. In FIG. 7, the three curves respectively represent the backlight spectrum curve of a conventional backlight module and the backlight spectrum curves of the two embodiments (Embodiment 1 and Embodiment 2) in which the doping concentrations (quantity of particles/μm²) are different. Herein the ratio of the doping concentration of phosphor of first replaceable optical element to the doping concentration of phosphor of second replaceable optical element in Embodiment 1 is 1.0X:1.0Y (wherein X, Y are positive real numbers). And in Embodiment 2 in which the doping concentrations of phosphors of first and second replaceable optical elements have been adjusted according to the specification of the color saturation, the ratio of the doping concentration of phosphor of first replaceable optical element to the doping concentration of phosphor of second replaceable optical element is 1.7X:1.5Y. Herein the doping concentrations of the phosphors can be adjusted by means of preparing the first and second replaceable optical elements with different doping concentrations (e.g., the first replaceable optical elements can be prepared to have the doping concentrations of 1.0X, 1.1X, . . . , 2.0X, and the second replaceable optical elements can be prepared to have the doping concentrations of 1.0Y, 1.1Y, . . . , 2.0Y), and then the doping concentrations of the phosphors can be adjusted by means of replacing or changing the first and second replaceable optical elements having different doping concentrations.

Referring to FIG. 7, since the backlight spectrum of the conventional backlight module is obtained by means of the yellow fluorescent powder being excited by the blue light emitting diode to form a mixed white light, there is no separate peak for each of red waveband and green waveband. On the other hand, since the blue light emitting diodes are used in Embodiment 1 and Embodiment 2, in which the two replaceable optical elements each having a single color phosphor and stacked together are excited to generate a mixed white light, each of the light spectrums has separate peaks in blue light, red light and/or green light waveband. Furthermore, in the embodiments, the luminous intensity of each light spectrum peak can be adjusted by changing the doping concentration of the phosphors. As shown in FIG. 7, the doping concentrations of the first phosphor and the second phosphor of Embodiment 2 are greater than the doping concentrations of the first phosphor and the second phosphor of Embodiment 1, thus the light spectrum peaks of the red light and green light wavebands of Embodiment 2 are higher than those of Embodiment 1, respectively.

By applying a panel to the three backlight modules, chromaticity coordinates of red, green and blue vertices of the panel with each of the three backlight modules can be calculated respectively. The red, green and blue vertices of the panel with the corresponding backlight module form a triangle and its area can be used to calculate color saturation.

As shown in Table 1, since the backlight modules of the embodiments uses the blue light emitting diodes to excite the red phosphor and the green phosphor to generate a mixed white light, the color saturations of the embodiments are higher. More specifically, the color saturation of the panel with the conventional backlight module in which a blue light emitting diode is used to excite the yellow fluorescent powder to generate a mixed white light is 49.04%, and the chromaticity coordinates of the white light is W(x,y)=(0.2896,0.2924). Comparatively, the panel with the backlight module of Embodiment 1 and the panel with the backlight module of Embodiment 2 have a higher color saturation. Herein, when the first replaceable optical element and the second replaceable optical element having the doping concentration ratio of 1.0X:1.0Y are used (i.e., Embodiment 1), the chromaticity coordinates of the white light is W(x,y)=(0.2674,0.2923), and the color saturation is 69.36%. In addition, when the first replaceable optical element and the second replaceable optical element having the doping concentration ratio of 1.7X:1.5Y are used (i.e., Embodiment 2), the chromaticity coordinates of the white light is W(x,y)=(0.313,0.3299), and the color saturation is 73.65%. Accordingly, the luminous intensity of the three-color backlight spectrum can be more evenly distributed by adjusting the doping concentration of the phosphor of each of the replaceable optical elements, and the color saturation can be greatly improved, for example, the color saturation is enhanced from 69.36% in Embodiment 1 to the color saturation of 73.65% in Embodiment 2.

On the other hand, the backlight module of the embodiment can obtain the color saturation which is close to the desired color saturation, i.e., the chromaticity coordinates of white light W(x,y)=(0.313,0.3299) of the color gamut (FIG. 2). As shown in Table 1, the white light of the conventional backlight is a cool color slightly close to blue color light. Comparatively, since the backlight module of the embodiment has separate spectrum peak of each of red, green and blue color corresponding to the red color filter, green color filter and blue color filter of the panel, specifications of the desired color saturation can be rapidly achieved by adjusting the doping concentration of the phosphor of each of the replaceable optical elements.

TABLE 1

| | W(x, y) | NTSC (%) |
|---|---|---|
| Conventional | (0.2896, 0.2924) | 49.04 |
| Embodiment 1 | (0.2674, 0.2923) | 69.36 |
| Embodiment 2 | (0.3139, 0.3299) | 73.65 |

In light of the foregoing, the backlight modules of the embodiments of the present invention have replaceable optical elements stacked together and the phosphor of each of the replaceable optical elements can be excited and mixed to form a white light, thus separate spectrum peak of each blue light, red light and/or green light respectively corresponding to the color filters can be obtained, and a broader color gamut or a better color saturation can be further achieved. In addition, rapidly adjusting the existing replaceable optical elements according to the desired color saturation may greatly reduce the development duration and fabrication cost. Furthermore, according to the backlight module of the embodiment of the present invention, the material and the doping concentration of the phosphor of each of the replaceable optical elements can be changed and adjusted, so that a source material data base can be established according to the resulting luminous intensity and the wavelength range of the excited light. Accordingly, under the condition of different light sources and different color filters, the desired color saturation can be simply and conveniently achieved by changing or replacing the replaceable optical elements according to the source material data base.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module comprising:
a light source emitting a first light; and
a group of replaceable optical elements receiving the first light and exciting a backlight light, wherein the group of replaceable optical elements comprise:
a first replaceable optical element, wherein the first replaceable optical element has a first phosphor, and the first phosphor is excited by a light and emits a second light; and
a second replaceable optical element, wherein the second replaceable optical element has a second phosphor, and the second phosphor is excited by a light and emits a third light.

2. The backlight module as claimed in claim 1, wherein the first replaceable optical element is a light guide plate, a diffusion film or a prism film and the second replaceable optical element is a light guide plate, a diffusion film, or a prism film.

3. The backlight module as claimed in claim 1, wherein the first phosphor is disposed in the first replaceable optical element by doping, and a doping concentration of the first phosphor is related to a luminous intensity of the second light.

4. The backlight module as claimed in claim 1, wherein the first phosphor is disposed on the first replaceable optical element by coating, and a thickness of the first phosphor is related to a luminous intensity of the second light.

5. The backlight module as claimed in claim 1, wherein the second phosphor is disposed in the second replaceable optical element by doping, and a doping concentration of the second phosphor is related to a luminous intensity of the third light.

6. The backlight module as claimed in claim 1, wherein the second phosphor is disposed on the second replaceable optical element by coating, and a thickness of the second phosphor is related to a luminous intensity of the third light.

7. The backlight module according to claim 1, wherein the light source is at least one blue light emitting diode, and the first light is a blue light.

8. The backlight module as claimed in claim 7, wherein the second light is a red light, and the third light is a green light.

9. The backlight module as claimed in claim 1, further comprising a third replaceable optical element, wherein the third replaceable optical element has a third phosphor, and the third phosphor is excited by a light and emits a fourth light.

10. The backlight module as claimed in claim 9, wherein the light source is at least one invisible light emitting diode, and the first light is an invisible light.

11. The backlight module as claimed in claim 9, wherein the third phosphor is disposed in the third replaceable optical element by doping, and a doping concentration of the third phosphor is related to a luminous intensity of the fourth light.

12. The backlight module as claimed in claim 9, wherein the third phosphor is disposed on the third replaceable optical element by coating, and a thickness of the third phosphor is related to a luminous intensity of the fourth light.

13. The backlight module as claimed in claim 9, wherein the second light is a red light, the third light is a green light, and the fourth light is a blue light.
